(19) United States
(12) Patent Application Publication
(10) Pub. No.: US 2026/0346773 A1
(43) Pub. Date: Nov. 5, 2026

(54) Vehicle Seat with Integral Calf Support

(71) Applicant: Bayerische Motoren Werke Aktiengesellschaft, Muenchen (DE)

(72) Inventors: Michael LENG, Geltendorf (DE); Yannick SCHWEITZER, Eichenau (DE)

(21) Appl. No.: 19/488,128

(22) PCT Filed: May 23, 2024
(86) PCT No.: PCT/DE2024/100475

§ 371 Date: Nov. 26, 2025

(30) Foreign Application Priority Data
May 31, 2023 (DE) 10 2023 114 275.5

(51) Int. Cl. B60N 2/90

(52) U.S. Cl. CPC B60N 2/995

(57) ABSTRACT

A vehicle seat has a seat surface with at least one thigh rest and a pivotable and extendable calf support. The vehicle seat is distinguished in that the thigh rest and the calf support have a common cover. The common cover is stretched during a movement of the calf support along a movement path between two positions of the calf support, and pivoting of the calf support is coupled to movement of the calf support.

### BACKGROUND AND SUMMARY

The invention relates to a vehicle seat comprising a seat surface with at least one thigh support, and a pivotable and extendable calf support. The invention further relates to a vehicle having such a vehicle seat.

Vehicle seats are equipped with calf supports to allow passengers to sit comfortably while traveling. The calf supports are often adjustable, such that the calf support can be pivoted out or pivoted in as required. The aim is to attach such calf supports to the thigh support with as few gaps as possible, such that a corresponding continuous support surface is created. However, vehicle seats having a calf support and a cover that extends over the calf support and at least as far as the thigh support have the problem that the cover crumples or creases during a pivoting of the calf support.

For example, a vehicle seat having an adjustable calf support is known from DE 10 2019 206 121 A1. The calf support is pivotably mounted with a first end on a seat at a joint, and it also has a free end. Between the pivotably mounted first end and the free end, the calf support has pivotable joints of a guide chain under an upholstery cushion, which joints allow the calf support to move between a straight, outwardly pivoted position and a retracted, U-shaped position. The calf support can be pivoted via a linear actuator that is articulated at the free end of the guide chain. The pivotable joints serving as chain links are at different distances from one another in the two positions, which has a detrimental effect on the movement of a cover arranged above them, since it can cause the cover to crumple and crease between the chain links. Furthermore, the upholstery only rests on the calf support and is therefore not supported by the calf support in every position, which can have the detrimental effect of causing the upholstery to become kinked in the outwardly pivoted end position.

The problem addressed by the present invention is to provide a vehicle seat having a calf support, the cover of which performs an improved movement. A further problem addressed by the present invention is to make available a vehicle having such a vehicle seat.

The problems are solved by a vehicle seat and by a vehicle that has such a vehicle seat in accordance with the independent claim(s).

In a vehicle seat comprising a seat surface with at least one thigh support and a pivotable and movable calf support, provision is made that the thigh support and the calf support have a common cover, and that the common cover is tensioned during a movement of the calf support along a movement path between two positions of the calf support, in particular between two end positions, and that a pivoting of the calf support is coupled to a movement of the calf support.

By virtue of the fact that the thigh support and the calf support have a common cover and that the latter is essentially always tensioned during the movement of the calf support, it is advantageously possible to prevent the cover from crumpling. On the one hand, crumpling can lead to kinking of the fibers of the cover, and therefore the invention is able to increase the service life of the cover. On the other hand, crumpling can lead to an unpleasant feeling for a person sitting on the vehicle seat, because the cover forms undulations. Tightening therefore also advantageously results in a somatosensory improvement. The fact that the movement and the pivoting are coupled results in a particularly simple movement path on which the cover is essentially always taut.

The movement of the calf support can be an extension and outward pivoting movement and a retraction and inward pivoting movement, wherein the pivoting can be the outward pivoting movement and inward pivoting movement, and wherein the movement can be the extension and retraction movement. The calf support can have a free end portion and/or an articulation portion. The movement is a stretching of the calf support and/or displacement of the calf support, in particular of the end portion of the calf support, relative to a pivot axis of the calf support. The common cover can be attached at least to one end of the thigh support facing the calf support and can stretch over a part of the calf support that changes in length. In particular, the cover can stretch over the entire length of the calf support and/or around a free end of the calf support, in particular around the free end portion.

It can be provided that at least one additional middle supporting portion is provided. The free end portion can be connected extendably to the articulation portion, in particular on one or more rails, particularly preferably telescopic rails. For its part, the articulation portion can be pivotably connected to the rest of the vehicle seat, in particular to the thigh support or to an intermediate part between thigh support and calf support. Finally, the seat surface can comprise a rear seat surface that is arranged on a seat back. The rear seat surface can also be upholstered by the common cover. The cover can be part of an upholstery and in particular can be attached to an upholstery cushion. The calf support can be designed to be extendable by a longitudinal adjustment device. The calf support can be designed to be pivotable by a pivot angle adjustment device. The two positions are spaced apart from each other by at least 50%, preferably 70%, in particular 90% of the movement path, or they are two end positions.

Further preferred and advantageous design features of the vehicle seat according to the invention are the subject matter of the dependent claims.

In a first embodiment of the vehicle seat according to the invention, the cover can comprise an elastic material, for example textile material, in particular an elastic fiber, particularly preferably comprising a material such as a woven fabric, a knitted fabric and/or a warp-knitted fabric, which is held in an elastic tension range over the movement path of the calf support. This makes it easier to more effectively prevent crumpling. The elastic tension range can be limited to a first third, preferably a first quarter of the elasticity line of the elastic material. This can advantageously increase the service life of the textile material. However, the elastic material can also be formed of leather or synthetic leather or can comprise the latter in combination with a textile material.

In a further embodiment of the vehicle seat according to the invention, a change in length of the cover in the region of the calf support along the movement path is at most 5%, in particular at most 3%, particularly preferably at most 2%. This advantageously prevents the cover from being tightened too much. The cover therefore has a neutral fiber whose length scarcely changes.

In an advantageous development, provision can be made that the calf support is designed to be movable by a longitudinal adjustment device, that the calf support is designed to be pivotable by a pivot angle adjustment device, and that the longitudinal adjustment device and the pivot angle adjustment device have a common coupling device, wherein the coupling device couples the pivoting of the calf support and the movement of the calf support. A longitudinal adjustment device can preferably comprise a linear actuator that can linearly extend a free end portion of the calf support. For this purpose, the longitudinal adjustment device can have rails for guiding the free end portion along an articulation portion connected to a pivot axis. The rails can be of telescopic design. The linear drive can be formed, for example, by a worm gear or an electromagnetic linear drive. The pivot angle adjustment device can, for example, have a linear actuator that is arranged eccentrically with respect to an axis of rotation of the pivot angle adjustment device and pivots the calf support about the axis of rotation. A further rotation joint and/or a slide can be provided at an engagement point on the free end portion. The coupling device can be of a mechanical or electronic design, for example. The coupling device can be a kinematic coupling device, in which case the paths of the pivot angle adjustment device and of the longitudinal adjustment device are predefined kinematically. For example, the paths can be kinematically determined using rails or joints. The coupling device can also be a control device that individually controls an actuator for the longitudinal movement of the calf support, in particular of a free end portion of the calf support, and a further actuator for the rotational movement of the calf support about an axis of rotation. The kinematic and electronic coupling can also be combined.

In a further preferred embodiment, provision can be made that the common coupling device couples a pivot angle of the pivot angle adjustment device and a longitudinal displacement of the longitudinal adjustment device along the movement path to each other, in particular linearly. The longitudinal displacement can be the movement of an end portion of the calf support relative to an articulation portion. The pivot angle can be the angle of a rotation of the calf support about an axis of rotation.

In a further development, provision can be made that a change in the longitudinal displacement of the longitudinal adjustment device and a change in a circular arc of the cover, spanned by the pivot angle, along the movement path have a coupling value, wherein in particular the coupling value can be between 1.2 and 2.5, in particular between 1.3 and 2.2. The coupling value can be a slope of a linear equation which linearly couples the pivot angle to the longitudinal displacement. Accordingly, a coupling ratio of length change to angle change is between 1:1.2 and 1:2.5, preferably between 1:1.3 and 1:2.2. In addition or alternatively, a sum of the longitudinal displacement of the longitudinal adjustment device and a circular arc of the cover spanned by the pivot angle can experience a maximum change of 10%, in particular 5%, on the movement path. The coupling value does not necessarily have to be constant, but can fluctuate around a value, wherein the fluctuation should be small and not more than 10%, preferably not more than 5%. The longitudinal displacement corresponds to the extension movement of the calf support, without taking the pivoting movement into account. The circular arc is spanned between the two positions and describes the proportion of the pivoting movement on the movement path without the longitudinal displacement or the movement of the calf support. In other words, the circular arc corresponds to the proportion of the cover that would be crumpled if there were no tension.

Moreover, in an advantageous further development, provision can be made that, when the movement path follows a direction from an inwardly pivoted and retracted end position to an outwardly pivoted and extended end position, the longitudinal adjustment device extends, in particular at least in sections along the movement path, prior to a movement of the pivot angle adjustment device, and/or that, when the movement path follows a direction from an outwardly pivoted and extended end position to an inwardly pivoted and retracted end position, the pivot angle adjustment device moves, in particular at least in sections along the movement path, prior to a movement of the longitudinal adjustment device. This achieves a tightening of the cover in a simple manner.

In a further embodiment of the invention, provision can be made that the cover slides, at least over a first region, on an end of the calf support facing the thigh support and is held on and/or fastened to the thigh support in a second region. By movement of the second region relative to the first region of the thigh support, it is advantageously possible, in a particularly simple manner, to tighten the cover during the adjustment. The first region can have a sliding point, a sliding line or a sliding surface. The first region can also be a middle region of the cover.

The invention can be further developed such that the common kinematic coupling device couples a pivot angle of the pivot angle adjustment device and a longitudinal displacement of the longitudinal adjustment device along the movement path in such a way that a maximum pivot angle and a maximum displacement are achieved simultaneously, in particular exclusively simultaneously, particularly preferably in an outwardly pivoted and extended end position, and/or that a minimum pivot angle and a minimum displacement are achieved simultaneously, in particular exclusively simultaneously, particularly preferably in an inwardly pivoted and retracted end position.

Furthermore, in an advantageous development, the longitudinal adjustment device can be adjustable by a first linear actuator, in particular the first linear actuator can be arranged in a first, in particular upper, region of the calf support designed preferably as an articulation portion and linearly displaces a second, in particular lower, region of the calf support designed preferably as a free end portion.

Finally, provision can be made that the pivot angle adjustment device is adjustable by a first linear actuator, in particular in that the second linear actuator is arranged on the thigh support eccentrically with respect to a rotation point of the calf support, particularly preferably in that the second linear actuator, seen in the vehicle longitudinal direction, is arranged on the thigh support behind a rotation point of the calf support.

A further aspect of the invention relates to a vehicle having a vehicle seat as described above.

Preferred exemplary embodiments of the invention, with additional design details and further advantages, are described and explained in more detail below with reference to the accompanying drawings.

### BRIEF DESCRIPTION OF THE DRAWINGS

FIG. 1 shows an interior of an exemplary embodiment of a vehicle according to the invention, with an exemplary embodiment of a vehicle seat according to the invention.

FIG. 2 is a schematic representation of the motion variables of the kinematics of the exemplary embodiment of the vehicle seat according to the invention.

### DETAILED DESCRIPTION OF THE DRAWINGS

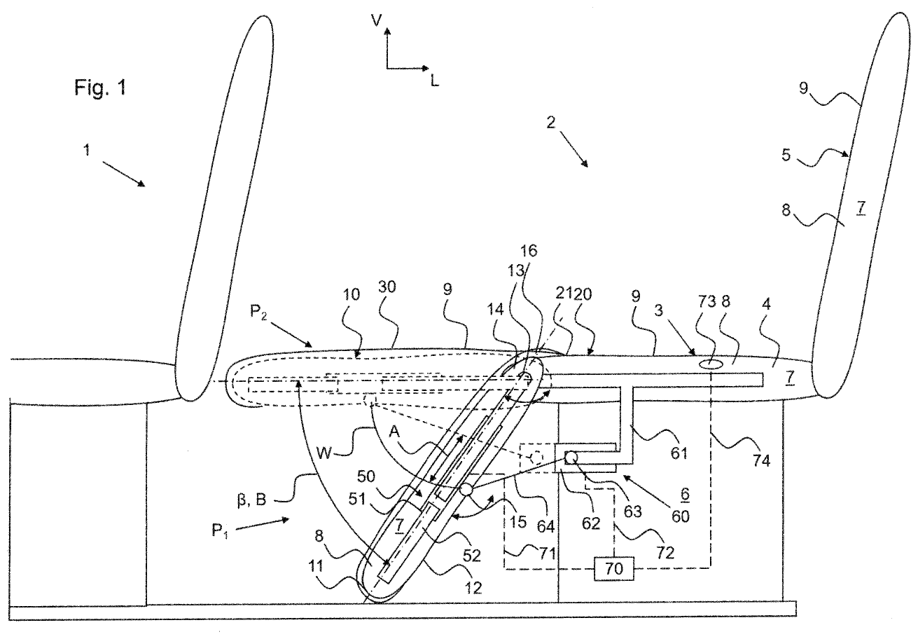

FIG. 1 shows an exemplary embodiment of a vehicle seat 2 in a vehicle 1 in a side view, with indication of a vehicle longitudinal direction L and a vehicle vertical direction V. The vehicle seat 2 comprises a pivotable and extendable calf support 10 and a seat surface 3, the latter being formed at least by a thigh support 20 in a front region of the seat surface 3. The calf support 10 serves to support the legs and calves of the passenger and thus promote blood circulation and reduce fatigue. The thigh support 20 is important for seating comfort in the sense that it supports the thighs of a passenger and reduces the pressure on them. Moreover, the seat surface 3 has a seat cushion 4 in a rear region. Finally, the vehicle seat 2 comprises a backrest 5. A lower pedestal 6 of the vehicle seat 2 forms a base and a mounting point for the vehicle seat 2 in the vehicle 1.

The calf support 10, the seat surface 3, in particular the thigh support 20, and the backrest 4 are covered with upholstery 7 to enable a passenger to sit comfortably. The upholstery 7 consists of upholstery cushions 8 and covers 9, wherein the calf support 10 and the thigh support 20 have a common cover 30, which is attached at one end to the thigh support 20 at an attachment point 21, is stretched over the calf support 10 and over a free end portion 11 of the calf support 10, and is attached to an underside 12 of the calf support 10. The attachment point 21 can also be arranged at an end of the thigh support 20 facing the backrest 4. The cover 30 in the region of the calf support 10 can slide along the calf support 10 over a first region with a sliding point 16. The sliding point 16 is only a point in the side view, because the material slides in space over a sliding line or sliding surface or over a region with the sliding point 16. For the sake of a better clarity, only one sliding point 16 is indicated; however, a large number of sliding points or one or more sliding surfaces can be provided between the two attachment points. The sliding point 16 is arranged at a distance from the first axis of rotation 13, so that a sliding path of the cover 30 in the region of the first axis of rotation 13 runs eccentrically thereto. The eccentricity results from an upholstery thickness or the thickness of the upholstery cushion 8 that is arranged around the first axis of rotation 13. In the present exemplary embodiment, the upholstery thickness is 20 mm, but it can preferably also be in a range of 10 mm to 30 mm. The common cover 30 is stretched during a movement of the calf support 10 along a movement path W between two positions P1, P2, in particular end positions, of the calf support 10. The cover 30 is an elastic textile material which, over the movement path W of the calf support 10, is held in an elastic tension range, i.e. in an elastic range in a stress-strain diagram of the material, while at the same time a change in length of the cover 30 in the region of the calf support 10 along the movement path W is at most 2%. These measures can already very effectively reduce crumpling and strain of the cover 30. The first position P1 is the inwardly pivoted and retracted position, and the second position P2 is the outwardly pivoted and extended position of the calf support 10, with the second position P2 being shown in dashed lines.

The calf support 10 is pivotably connected to the thigh support 20 at a first axis of rotation 13 by an articulation portion 14 of the calf support 10. The calf support 10 also has a second axis of rotation 15 in a central region of the calf support 10 at a distance from the first axis of rotation 13, on which second axis of rotation a linkage 64 is articulated, as will be described in more detail below, in order to transmit a torque to the calf support 10 and to pivot same. The calf support 10 is designed to be extendable by a longitudinal adjustment device 50, wherein the longitudinal adjustment device 50 is formed at least by a first linear actuator 51 and longitudinally extendable telescopic rails 52. The linear actuator 51 can extend the free end portion 11 along a longitudinal displacement A away from the articulation portion 14 and retract it toward the articulation portion 14. The first linear actuator 51 is arranged in a first upper region, the articulation portion 14 of the calf support 10.

In and below the thigh support 20, an angled frame arm 61 is arranged eccentrically with respect to the first axis of rotation 13, at the projecting free end of which frame arm a second linear actuator 62 is provided, which can linearly move a third axis of rotation 63 and the abovementioned linkage 64 in order to transmit a torque to the calf support 10 through the eccentricity with respect to the first axis of rotation 13. The eccentrically arranged frame arm 61, the second linear actuator 62, the third joint 63 and the linkage 64 are part of a pivot angle adjustment device 60. The pivot angle adjustment device 60 pivots the calf support 10 through a pivot angle β about the first axis of rotation 13. The pivot angle β is plotted between the same point on two straight lines drawn as dash-dot lines, which run through the first linear actuator 51 and the first axis of rotation 13, in the two positions P1, P2.

The two positions P1, P2 are shown schematically for the sake of clarity and do not necessarily correspond to the actual positions of the calf support 10, wherein the first position P1 is preferably a zero position, i.e. a direction of the longitudinal displacement A runs parallel or approximately parallel to a vertical direction V in this first position P1.

The longitudinal displacement A and the pivoting through the pivot angle β are linearly coupled by a common coupling device 70 designed as a control device, wherein the coupling device 70 is electronically connected via control lines 71, 72 to the first linear actuator 51 and second linear actuator 62 in order to be able to send control signals to the linear actuators 51, 62. Accordingly, the movement path W is a linear combination of longitudinal displacement A and the pivoting through the pivot angle β and is shown distorted accordingly and is thus also distorted compared to a circular arc B spanned by the pivot angle β. The course of the control lines 71, 72 is also only shown schematically here.

By means of an operating unit, for example a slider 73, which is connected via a further control line 74 to the coupling device 70 designed as a control device, the calf support 10 can be adjusted in an uncomplicated manner without causing crumpling of the cover 30.

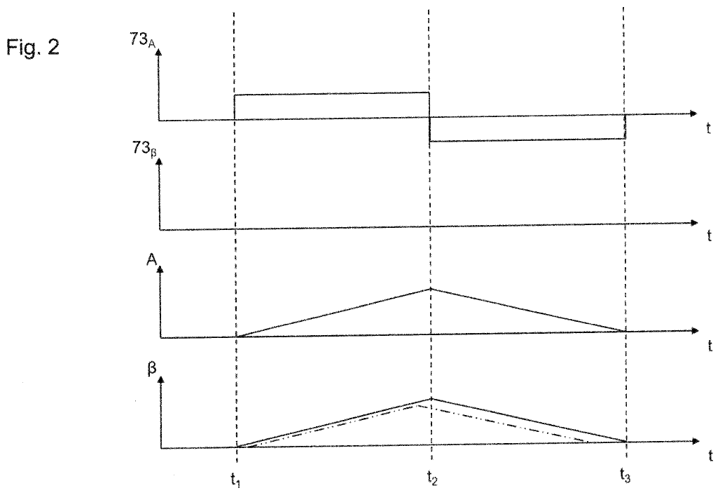

FIG. 2 provides a closer look at the control commands. Four diagrams are shown, each divided into a first time period from a first time t1 to a second time t2 and a second time period from the second time t2 to a third time t3. In the first diagram at the top, a first control command 73A of the longitudinal displacement A is plotted against time. This shows an initially positive, then negative rectangular curve, which corresponds to an extension command in the first time period and to a retraction command in the second time period. The second diagram shows a second control command 73β of the pivot angle β. In the present exemplary embodiment, this is always zero or, advantageously, does not have to exist, because the pivot angle β is coupled to the longitudinal displacement A. The third diagram and the fourth diagram show the reactions of the longitudinal displacement A and of the pivot angle β to the adjustment request, that is to say to the first control command 73A from the operating unit 73. Both are linearly coupled and move with a coupling value of 1.5 and thus lie in the inventive range of 1.2 to 2.5. The common coupling device 70 couples the pivot angle β of the pivot angle adjustment device 60 and the longitudinal displacement A of the longitudinal adjustment device 50 along the movement path W such that a maximum pivot angle and a maximum displacement are achieved simultaneously in an outwardly pivoted and extended position P2, and that a minimum pivot angle and a minimum displacement are achieved simultaneously in an inwardly pivoted and retracted position P1. In a possible alternative setting, which is shown in the fourth diagram by dash-colon curves, provision can be made that, when the movement path W follows a direction from an inwardly pivoted and retracted position P1 to an outwardly pivoted and extended position P2, the longitudinal adjustment device 50 extends prior to a movement of the pivot angle adjustment device 60 and/or that, when the movement path follows a direction from an outwardly pivoted and extended position P2 to an inwardly pivoted and retracted position P1, the pivot angle adjustment device 60 moves prior to a movement of the longitudinal adjustment device 50. The curves are only indicated relatively in order to illustrate the temporal offset and are not intended to show a change in the movement variables.

The design of the coupling device 70 as an electronic control device is not absolutely necessary. Provision can also be made that the coupling takes place purely kinematically, i.e. via corresponding mechanical constraints such as corresponding rails and rods. The advantage of an electronic control device is that the coupling device can be switched off if necessary, for example in order to carry out only a longitudinal displacement A, for example if the cover 30 is to be tightened in a readjustment.

The invention is not limited to the above exemplary embodiment, which merely serves to generally explain the core concept of the invention. Rather, within the scope of protection, the device according to the invention can also assume configurations other than those that have been described above. In this case, the device can in particular have features which represent a combination of the respective individual features of the claims.

Reference signs in the claims, the description and the drawings serve only to provide a better understanding of the invention and are not intended to limit the scope of protection.

### LIST OF REFERENCE SIGNS

1 vehicle
2 vehicle seat
3 seat surface
4 seat cushion
5 backrest
6 pedestal
7 upholstery
8 upholstery cushion
9 covers
10 calf support
11 free end portion/lower, second region of calf support
12 underside of calf support
13 first axis of rotation
14 articulation portion/upper, first region of calf support
15 second axis of rotation
16 first region with a sliding point, a sliding line and/or sliding surface
20 thigh support
21 second point, attachment point
30 common cover
50 longitudinal adjustment device
51 first linear actuator
52 telescopic rails
60 pivot angle adjustment device
61 frame arm
62 second linear actuator
63 third axis of rotation
64 linkage
70 coupling device
71 first control line
72 second control line
73 operating unit 73A first control command
73β second control command 74 third control line
P1 first position, in particular first end position, retracted and pivoted inward
P2 second position, in particular second end position, extended and pivoted outward
W movement path
A longitudinal displacement
β pivot angle
B circular arc
t1 first time
t2 second time
t3 third time
L vehicle longitudinal direction
V vehicle vertical direction

1.-12. (canceled)

13. A vehicle seat for a vehicle, comprising:
a seat surface with at least one thigh support and a pivotable and movable calf support;
a common cover for the thigh support and the calf support, wherein
the common cover is stretched during movement of the calf support and/or during a displacement of an end portion of the calf support relative to a pivot axis of the calf support,
the common cover is tensioned during a movement of the calf support along a movement path between two positions of the calf support, and
a pivoting of the calf support is coupled to the movement of the calf support.

14. The vehicle seat according to claim 13, wherein the cover comprises an elastic material which is held in an elastic tension range over the movement path of the calf support.

15. The vehicle seat according to claim 13, wherein
a change in length of the cover in a region of the calf support along the movement path is at most 5%.

16. The vehicle seat according to claim 13, wherein
a change in length of the cover in a region of the calf support along the movement path is at most 2%.

17. The vehicle seat according to claim 13, further comprising:
a longitudinal adjustment device by which the calf support is configured to be movable; and
a pivot angle adjustment device by which the calf support is designed to be pivotable,
wherein the longitudinal adjustment device and the pivot angle adjustment device have a common coupling device,
wherein the common coupling device couples the pivoting of the calf support and the movement of the calf support to each other.

18. The vehicle seat according to claim 17, wherein
the common coupling device couples a longitudinal displacement of the longitudinal adjustment device and a pivot angle of the pivot angle adjustment device, defined about an axis of rotation of the calf support, along the movement path to each other.

19. The vehicle seat according to claim 18, wherein
a change in the longitudinal displacement of the longitudinal adjustment device and a change in a circular arc of the cover, spanned by the pivot angle, along the movement path have a coupling value,
the coupling value is between 1.2 and 2.5, and/or
a sum of the longitudinal displacement of the longitudinal adjustment device and a circular arc of the cover, spanned by the pivot angle, along the movement path experiences a maximum change of 10%.

20. The vehicle seat according to claim 19, wherein the coupling value is between 1.3 and 2.2, and the maximum change is 5%.

21. The vehicle seat according to claim 17, wherein,
when the movement path follows a direction from an inwardly pivoted and retracted position to an outwardly pivoted and extended position, the longitudinal adjustment device extends prior to a movement of the pivot angle adjustment device, and/or
when the movement path follows a direction from an outwardly pivoted and extended position to an inwardly pivoted and retracted position, the pivot angle adjustment device moves prior to a movement of the longitudinal adjustment device.

22. The vehicle seat according to claim 17, wherein
the cover slides, at least over a first region, on an articulation portion of the calf support facing the thigh support and is held on and/or fastened to the thigh support in a second region.

23. The vehicle seat according to claim 17, wherein
the common coupling device kinematically couples a pivot angle of the pivot angle adjustment device and a longitudinal displacement of the longitudinal adjustment device along the movement path to each other such that:
a maximum pivot angle and a maximum displacement are achieved simultaneously, in an outwardly pivoted and extended end position, and/or
a minimum pivot angle and a minimum displacement are achieved simultaneously, in an inwardly pivoted and retracted end position.

24. The vehicle seat according to claim 17, wherein
the longitudinal adjustment device is adjustable by a first linear actuator,
the first linear actuator is arranged in a first, upper, region of the calf support designed as an articulation portion and linearly displaces a second, lower, region of the calf support designed as a free end portion.

25. The vehicle seat according to claim 17, wherein
the pivot angle adjustment device is adjustable by a second linear actuator,
the second linear actuator is arranged on the thigh support eccentrically with respect to a first rotation point of the calf support,
the second linear actuator, seen in the vehicle longitudinal direction, is arranged on the thigh support behind a first rotation point of the calf support.

26. A vehicle having at least one vehicle seat according to claim 13.
